(19) United States
(12) Patent Application Publication
(10) Pub. No.: US 2022/0161876 A1
(43) Pub. Date: May 26, 2022

(54) UNDERCARRIAGE SOIL DISBURSEMENT SYSTEM

(71) Applicant: Ronald Molgaard Christensen, Calgary (CA)

(72) Inventor: Ronald Molgaard Christensen, Calgary (CA)

(21) Appl. No.: 16/953,917

(22) Filed: Nov. 20, 2020

(51) Int. Cl. B62D 55/088

(52) U.S. Cl. CPC B62D 55/0882

(57) ABSTRACT

A soil disbursement system is provided. An undercarriage soil disbursement system for a heavy equipment vehicle including a vehicle body and an undercarriage including a track, comprising one or more conveyors configured to be mounted within the undercarriage for collecting debris from the tracks and discharging the debris out a side of the undercarriage, a drive for actuating the one or more conveyors and one or more sweeping blades configured to be mounted on an underside of the vehicle body, whereby during rotation of the vehicle body the sweeping blades push debris from the track onto the one or more conveyors.

### FIELD OF THE INVENTION

The present disclosure relates to a soil disbursement system, specifically to an undercarriage soil disbursement system, more specifically to a soil disbursement system situated in the undercarriage of a heavy equipment vehicle.

### BACKGROUND

The employment of heavy equipment vehicles for projects such as digging, lifting heavy objects, demolition, brush cutting, etc., often results with the heavy equipment vehicle having packed debris wedge into the tracks, between the frame rails in the undercarriage, and along the underside of the house. Heavy equipment vehicle operators working in muskeg, mud, and loose fill can attest to the misery of cleaning tracks at the end of every shift. The tracks, undercarriage and the underside of the house of these vehicles have to be cleaned for transportation of the vehicles on roads, to avoid any loss in the power of the vehicle due to the additional weight of the debris and to reduce any unnecessary wear on the equipment. This task is further complicated in winter months with the addition of snow, ice and frozen temperatures that solidify any compact muskeg, mud or loose fill within the tracks and undercarriage, which may contribute to locking moving components and mobility issues for the track. The time spent on daily maintenance as well as potential repairs on the heavy equipment vehicles equates to production and revenue lost.

Current devices for clearing debris within heavy equipment vehicles typically clear the wheel track of the heavy equipment vehicle with mechanical blades and often neglect the accumulation of debris along the underside of the house. Inefficient track cleaning systems leave the operator having to employ the use of tiger torches, pry bars and shovels to break loose and free up rollers and many other mechanical components required for further use or transportation of the vehicle.

U.S. Pat. No. 4,235,479 A (Puglise) discloses a dual mechanical pusher plates track cleaning system for a crawler-type vehicle. Shortcomings include a time consuming, inefficient installation of the pusher plates onto a crawler-type vehicle and a lack of flow-rate variability for the pusher plates.

U.S. Pat. No. 4,763,961 A (Parrott) discloses a shaped plate apparatus for removing and clearing debris between the frame and the track of a track type vehicle. Shortcomings include a time consuming, extensive installation of the apparatus onto a track type vehicle and a lack of flow-rate variability for the shaped plates.

U.S. Pat. No. 8,167,384 A (Tan) discloses a track roller frame cleaning mechanism. Shortcomings include a time consuming, extensive installation of the track roller frame cleaning mechanism onto a track-type machine and a lack of flow-rate variability for the slider.

All documents cited herein are incorporated by reference.

There is a need for an undercarriage soil disbursement system that utilizes one of more conveyors housed within the undercarriage of a heavy equipment vehicle and one or more sweeping blades underneath the base of a house of a heavy equipment vehicle to clear debris from the undercarriage and the base of the house, reducing maintenance times and associated revenue lost, averting unnecessary wear on the heavy equipment vehicles and money spent on repairs and is relatively simple to assemble and dismantle.

### BRIEF SUMMARY

It is the object of the present invention to provide a soil disbursement system.

In accordance with an aspect of the invention, there is provided an undercarriage soil disbursement system for a heavy equipment vehicle including a vehicle body and an undercarriage including a track, comprising one or more conveyors configured to be mounted within the undercarriage for collecting debris from the tracks and discharging the debris out a side of the undercarriage and a drive for actuating the one or more conveyors.

In accordance with another aspect of the invention, there is provided a method of retrofitting an undercarriage soil disbursement system onto a heavy equipment vehicle, comprising inserting one or more conveyors within an undercarriage onto a track frame of a heavy equipment vehicle wherein the one or more conveyors are orthogonal to a track of the heavy equipment vehicle and connecting a drive to the one or more conveyors within the undercarriage onto the track frame.

In accordance with an embodiment of the invention, the one or more conveyors are composed of a mountable frame.

In accordance with an embodiment of the invention, the undercarriage soil disbursement system further comprising one or more sweeping blades configured to be mounted on an underside of said vehicle body, whereby during rotation of said vehicle body said sweeping blades push debris from said track onto said one or more conveyors.

In accordance with an embodiment of the invention, the method of retrofitting an undercarriage soil disbursement system onto a heavy equipment vehicle further comprising mounting sweeping blades on an underside of said vehicle body, whereby during rotation of said vehicle body said sweeping blades push debris from the track and the underside of the vehicle body out a side of the undercarriage and onto the one or more conveyors.

In accordance with an embodiment of the invention, the drive comprises a hydraulic motor.

In accordance with an embodiment of the invention, the drive comprises a pneumatic motor.

In accordance with an embodiment of the invention, the drive comprises an electric motor.

In accordance with an embodiment of the invention, the drive employed is an existing drive on said heavy equipment vehicle.

In accordance with an embodiment of the invention, the conveyors and said drive are configured for a variable of speeds of said one or more conveyors.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system view 100 in accordance with one embodiment.

FIG. 2 illustrates an exploded view 200 in accordance with one embodiment.

FIG. 3 illustrates a conveyor 108 in accordance with one embodiment.

FIG. 4 illustrates a side view of a conveyor 400 in accordance with one embodiment.

FIG. 5 illustrates a single unit view 500 in accordance with one embodiment.

FIG. 6 illustrates an unassembled view 600 in accordance with one embodiment.

FIG. 7 illustrates an assembled view 700 in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

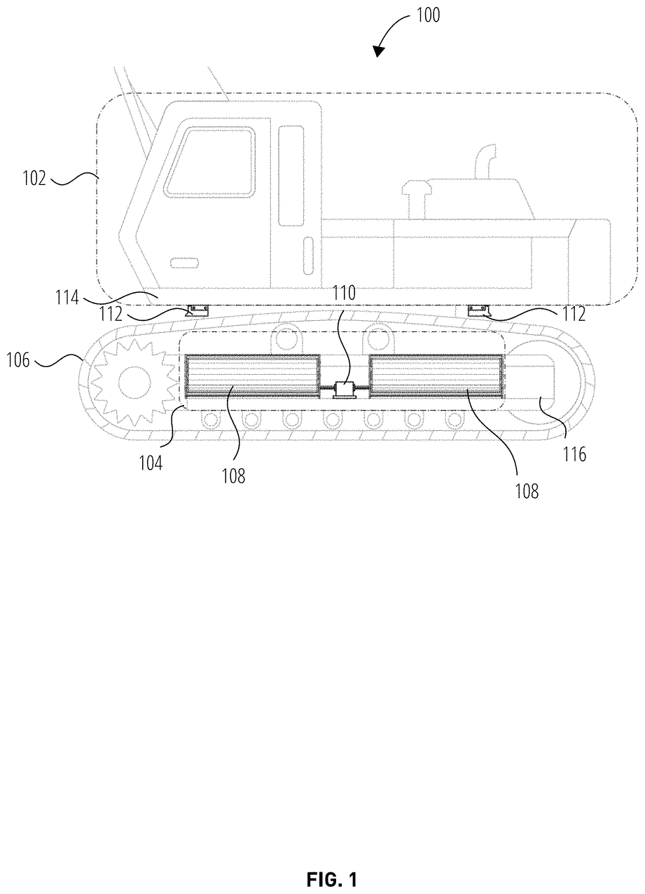

FIG. 1 depicts a system view 100 of an undercarriage soil disbursement system for a heavy equipment vehicle including a vehicle body 102 and an undercarriage 104 including a track 106, as in one embodiment. The undercarriage soil disbursement system comprises one or more conveyors 108 configured to be mounted within the undercarriage 104 for collecting debris from the track 106 and discharging the debris out a side of the undercarriage 104 and a drive 110 for actuating the one or more conveyors 108. In some embodiments, the undercarriage soil disbursement system is manufactured into a heavy equipment vehicle. In another embodiment, the undercarriage soil disbursement system further comprises one or more sweeping blades 112 configured to be mounted on an underside 114 of the vehicle body 102, whereby during rotation of the vehicle body 102 the sweeping blades 112 push debris from the track 106 and the underside 114 of the vehicle body 102 out the side of the undercarriage 104 and onto the one or more conveyors 108. In some embodiments, the one or more sweeping blades are manufactured into a heavy equipment vehicle.

Furthermore, a method of retrofitting the undercarriage soil disbursement system onto a heavy equipment vehicle comprises inserting one or more conveyors 108 within the undercarriage 104 onto the track frame 116 of the heavy equipment vehicle wherein the one or more conveyors 108 are orthogonal to the track 106 of the heavy equipment vehicle and a drive 110 is connected to the one or more conveyors 108 within the undercarriage 104 onto the track frame 116. In another embodiment, the method further comprises mounting sweeping blades 112 on an underside 114 of the vehicle body 102, whereby during rotation of the vehicle body 102 the sweeping blades 112 push debris from the track 106 and the underside 114 of the vehicle body 102 out the side of the undercarriage 104 and onto the one or more conveyors 108.

In the embodiment shown, two sweeping blades 112 are shown mounted to the underside 114 of the vehicle body 102, and two conveyors 108 are shown mounted and secured to the track frame 116 of the undercarriage 104. Each conveyor 108 is shown attached to a drive 110, such as a hydraulic motor. In another embodiment, the drive 110 is a pneumatic motor. In another embodiment, the drive 110 is an electrical motor. In another embodiment, the drive employed is an existing drive on the heavy equipment vehicle.

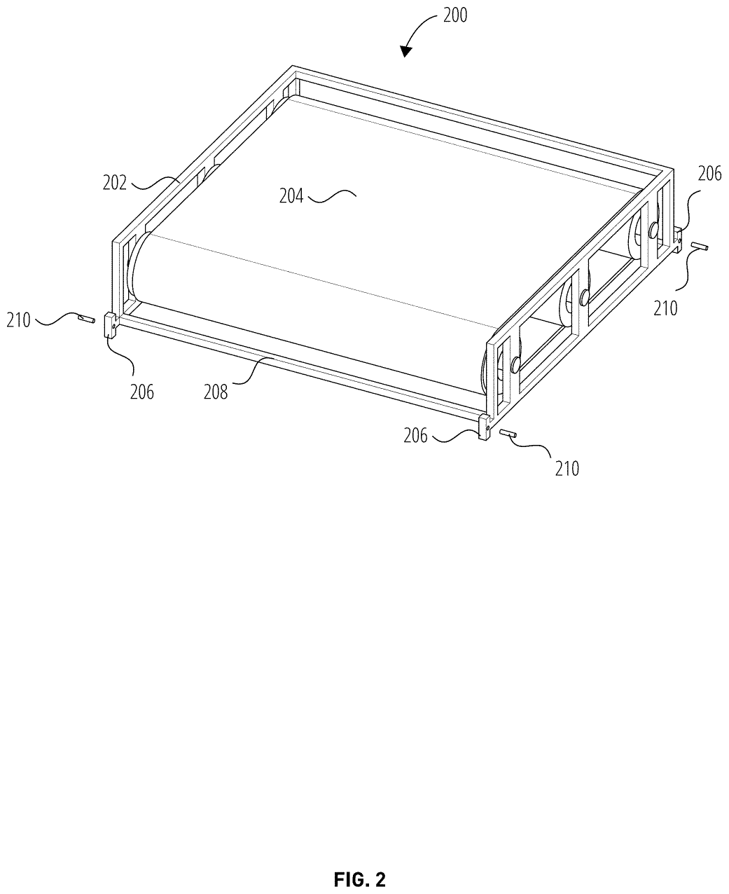

FIG. 2 depicts an exploded view 200 of the undercarriage soil disbursement system as in one embodiment. In this embodiment, the conveyor 108 for the undercarriage soil disbursement system is shown composed of a mountable frame 202, a conveyor belt 204 and a mounting bracket 206 at each corner of a base portion 208 of the mountable frame 202. The conveyor 108 is secured onto a track frame 116 through applying one or more mounting pins to the mountable frame 202 and the track frame 116. In this embodiment, each mounting pin 210 and the respective mounting bracket 206 are shown prior to attachment and assembly onto the track frame 116.

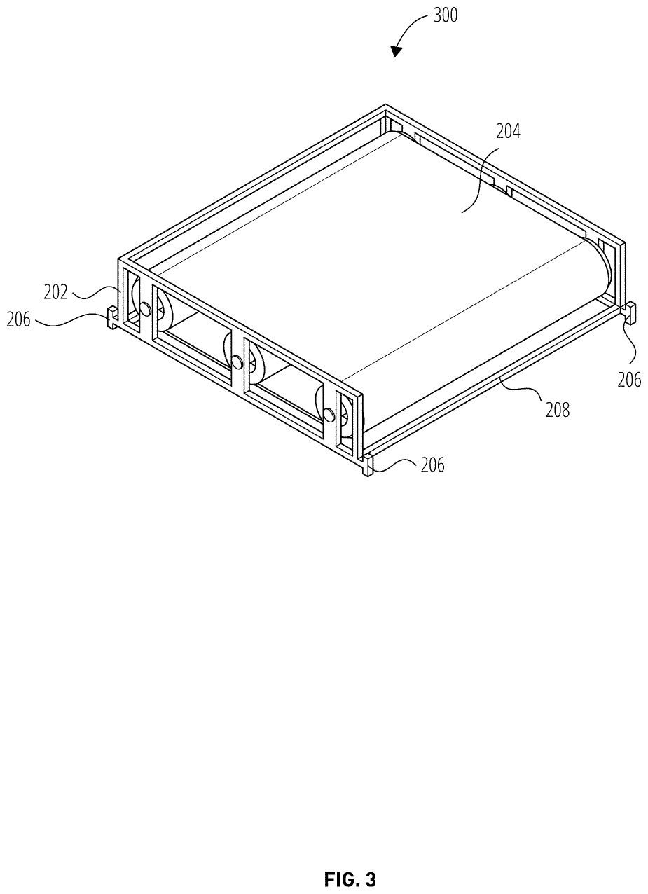

FIG. 3 depicts a perspective view 300 of a conveyor 108 of the undercarriage soil disbursement system as in one embodiment. In some embodiments, the one or more conveyors 108 are composed of a mountable frame 202 for relatively simple assembly and dismantling of the conveyor 108 to the heavy equipment vehicle. In some embodiments, the one or more conveyors 108 and the drive 110 are configured for variable speeds.

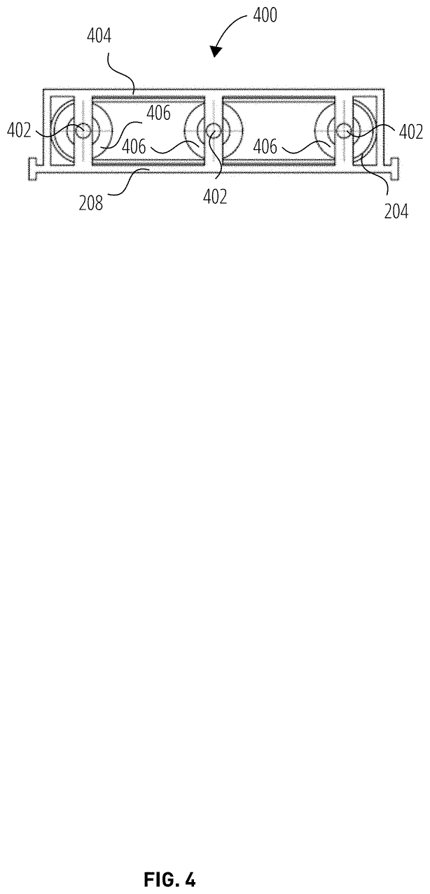

FIG. 4 depicts a perspective side view of a conveyor 400 of the undercarriage soil disbursement system as in one embodiment. In this embodiment, each support roller 406 and drive sprocket 402 are shown attached to the conveyor belt 204 in between the top portion 404 and the base portion 208 of the mountable frame 202

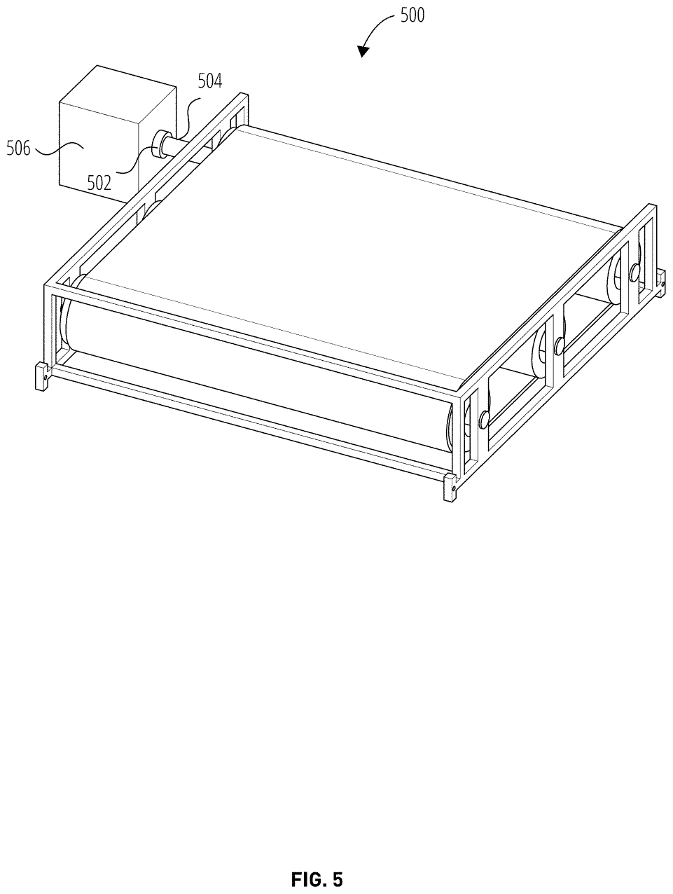

FIG. 5 depicts a single unit view 500 of the undercarriage soil disbursement system as in one embodiment. In some embodiments, the undercarriage soil disbursement system may be assembled through placing a drive 110 alongside one or more conveyors within the undercarriage 104 onto the track frame 116 of a heavy equipment vehicle. Prior to assembly, the drive 110 may be encased within a drive house 506 which has one or more holes for each output spline shaft 504 to connect with the drive 110. The drive house 506 may be secured through applying one or more mounting pins 210 to the drive house 506 and the track frame 116. Furthermore, one or more output spline shafts 504 may be connected to one or more conveyors 108 and the drive 110 via one or more connection fittings 502. In this embodiment, the conveyor 108 is shown connected to the drive 110 by an output spline shaft 504 via a connection fitting 502. In another embodiment, the drive house 506 flips open for easy access to the drive 110.

In some embodiments, the undercarriage soil disbursement system further comprises the drive 110 connected to one or more hydraulic lines via one or more connection fittings 502 where the hydraulic lines are connected to a solenoid valve via one or more connection fittings 502 not presently shown. Additionally, the hydraulic lines and the solenoid valve may be connected to a preexisting drive 110 of the heavy equipment vehicle via one or more connection fittings 502 with the solenoid valve connected to a switch via one or more wires not presently shown. In some embodiments, activating a switch triggers one or more conveyors 108 to transport debris present within the undercarriage 104 outward from the undercarriage 104, where the speed of the conveyors 108 may be controlled by a switch that is regulated from inside the cab of the heavy equipment vehicle.

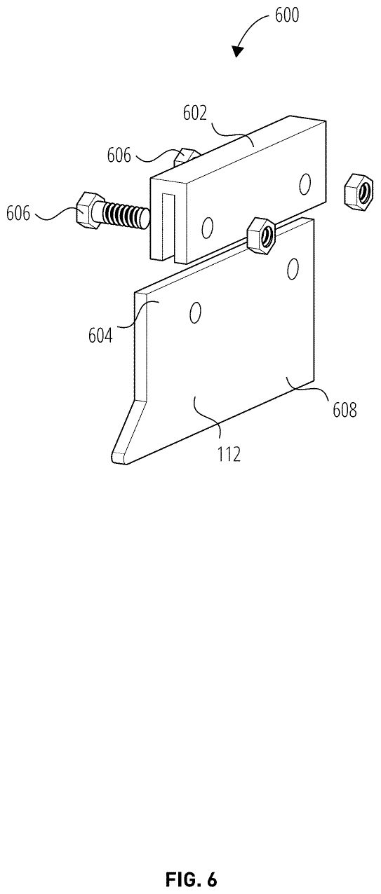

FIG. 6 depicts an unassembled view 600 of the sweeping blade 112 as in one embodiment. In this embodiment, a channel mount bracket 602, a sweeping blade 112 and each mounting bolt 606 are shown prior to attachment and assembly to the underside 114 of a heavy equipment vehicle. During assembly, one or more channel mount brackets 602 may be fused to the underside 114 of the vehicle body 102. For each channel mount bracket 602, a first side of a sweeping blade 604 is inserted inside of a respective channel mount bracket 602 and one or more mounting bolts are applied to secure the first side of a sweeping blade 604 to the channel mount bracket 602.

The second side of a sweeping blade 608 may be employed to clear debris onto the ground at the front and back of the heavy equipment vehicle and onto one or more conveyors 108 within the undercarriage 104 of the heavy equipment vehicle. The shape of the second side of a sweeping blade 608 may be altered to ensure that the sweeping blade 112 doesn't make contact with the track 106 or other components present between the track 106 and the vehicle body 102 of the heavy equipment vehicle. In another embodiment, one or more mounting pins 210 are employed in combination with or in place of the mounting bolts 606. In another embodiment, one or more sweeping blades 112 may be fused to the underside 114 of the vehicle body 102.

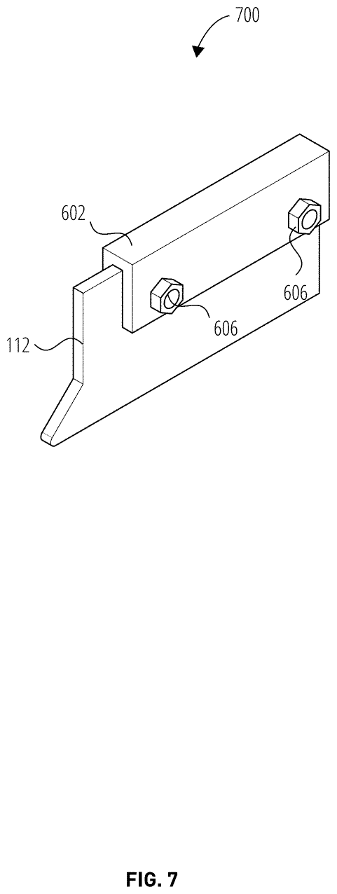

FIG. 7 depicts an assembled view 700 of the sweeping blade 112 as in one embodiment. In this embodiment, a sweeping blade 112 is shown assembled to a channel mount bracket 602 with two mounting bolts 606.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. An undercarriage soil disbursement system for a heavy equipment vehicle including a vehicle body and an undercarriage including a track, comprising:
one or more conveyors configured to be mounted within said undercarriage for collecting debris from said tracks and discharging said debris out a side of said undercarriage; and
a drive for actuating said one or more conveyors.

2. The system according to claim 1, wherein said one or more conveyors include a mountable frame.

3. The system according to claim 1, further comprising one or more sweeping blades configured to be mounted on an underside of said vehicle body, whereby during rotation of said vehicle body said sweeping blades push debris from said track and said underside of said vehicle body out said side of said undercarriage and onto said one or more conveyors.

4. The system according to claim 1, wherein said one or more conveyors and said drive are configured for variable speeds.

5. The system according to claim 1, wherein said drive comprises a hydraulic motor.

6. The system according to claim 1, wherein said drive comprises a pneumatic motor.

7. The system according to claim 1, wherein said drive comprises an electric motor.

8. The system according to claim 1, wherein said drive employed is an existing drive on said heavy equipment vehicle.

9. A heavy equipment vehicle including a vehicle body and an undercarriage including a track, comprising:
one or more conveyors configured to be mounted within said undercarriage for collecting debris from said tracks and discharging said debris out a side of said undercarriage; and
a drive for actuating said one or more conveyors.

10. The heavy equipment vehicle of claim 9, further comprising one or more sweeping blades configured to be mounted on an underside of said vehicle body, whereby during rotation of said vehicle body said sweeping blades push debris from said track and said underside of said vehicle body out said side of said undercarriage and onto said one or more conveyors.

11. A method of retrofitting an undercarriage soil disbursement system onto a heavy equipment vehicle, comprising:
inserting one or more conveyors within an undercarriage onto a track frame of a heavy equipment vehicle wherein said one or more conveyors are orthogonal to a track of said heavy equipment vehicle; and
connecting a drive to said one or more conveyors within said undercarriage onto said track frame.

12. The method according to claim 11, wherein said conveyors and said drive are configured for a variable of speeds of said one or more conveyors.

13. The method according to claim 11, further comprising mounting sweeping blades on an underside of said vehicle body, whereby during rotation of said vehicle body said sweeping blades push debris from said track and said underside of said vehicle body out a side of said undercarriage and onto said one or more conveyors.

14. The method according to claim 11, wherein said drive comprises a hydraulic motor.

15. The method according to claim 11, wherein said drive comprises a pneumatic motor.

16. The method according to claim 11, wherein said drive comprises an electric motor.

17. The method according to claim 11, wherein said drive employed is an existing drive on said heavy equipment vehicle.
